(19) United States
(12) Patent Application Publication
(10) Pub. No.: US 2013/0239563 A1
(43) Pub. Date: Sep. 19, 2013

(54) MONO-ENERGY AND/OR DUAL-ENERGY ENGINE WITH COMPRESSED AIR AND/OR ADDITIONAL ENERGY, COMPRISING AN ACTIVE CHAMBER INCLUDED IN THE CYLINDER

(71) Applicants: Guy Negre, Luxembourg (LU); Cyril Negre, Nice (FR)

(72) Inventors: Guy Negre, Luxembourg (LU); Cyril Negre, Nice (FR)

(73) Assignee: MOTOR DEVELOPMENT INTERNATIONAL S.A., Luxembourg (LU)

(21) Appl. No.: 13/822,946

(22) PCT Filed: Oct. 3, 2011
(86) PCT No.: PCT/EP2011/067211

§ 371 Date: Jun. 3, 2013

(30) Foreign Application Priority Data
Oct. 4, 2010 (FR) 1058005

(51) Int. Cl. F02G 1/02

(52) U.S. Cl. CPC F02G 1/02
USPC 60/517; 91/418

(57) ABSTRACT

An engine with an active chamber, having at least one piston (2) mounted in a cylinder (1) in a sliding manner and driving a crankshaft (5) via a slider-crank device (3, 4) and operating according to a four-phase thermodynamic cycle includes: an isothermal expansion without work; a transfer-slight so-called quasi-isothermal expansion with work; a polytropic expansion with work; and an exhaust at ambient pressure, preferentially supplied by compressed air contained in a high-pressure storage tank (12), through a buffer capacity, called a working capacity (11), which is expanded at an average pressure, called a working pressure, in a working capacity (11), preferentially through a dynamic pressure-reducing device (13), wherein the active chamber is included in the engine cylinder, the cylinder volume being swept by the piston and divided into two separate parts, a first part forming the active chamber and a second part forming the expansion chamber.

The invention relates to an engine operating notably on compressed air, or any other gas, using a chamber referred to as an “active chamber”.

The inventors have filed numerous patents regarding power plants and installations thereof, using gases and, more particularly, compressed air, for completely clean operation in urban and suburban situations:

In particular, they filed an international patent application WO-A1-03/036088, to the content of which reference can be made, regarding a motorized compressor/motorized alternator unit with injection of additional compressed air, operating in mono-energy and in multi-energy modes.

In these types of engine that operate on compressed air and comprise a compressed-air storage reservoir, it is necessary to expand the compressed air stored at a very high pressure in the reservoir but the pressure of which decreases as the reservoir gradually empties, to a stable intermediate pressure referred to as the end-use pressure, in a buffer volume—referred to as working volume—before it is used in the engine cylinder or cylinders.

Well known conventional regulators involving valves and springs have very low throughputs and their use in such an application demands equipment that is highly cumbersome and does not perform well. Further, they are highly sensitive to icing due to the moisture in the air cooled during the expansion.

In order to address this problem, the inventors have also filed a patent application WO-A1-03/089764, to the content of which reference can be made, relating to a variable throughput dynamic regulator and distribution system for engines supplied with an injection of compressed air, comprising a high-pressure compressed-air reservoir and a working volume.

In the operation of these “charge expansion” engines, the filling of the expansion chamber still represents an expansion without work that is detrimental to the overall efficiency of the machine.

In order to address the abovementioned problem, the inventors have filed yet another patent application WO-A1-2005/049968 describing a compressed-air engine preferably supplied with compressed air or any other compressed gas contained in a high-pressure storage reservoir previously expanded to a nominal working pressure in a buffer volume referred to as the working volume. The working volume in dual-energy version comprises an air-heating device supplied with additional energy (fossil or some other energy) for increasing the temperature and/or the pressure of the air passing through it.

In this type of engine according to WO-A1-2005/049968:
the expansion chamber consists of a variable volume fitted with means allowing the production of work, it is twinned and in contact via a permanent passage with the space left above the main engine piston which is fitted with a device for stopping the piston at top dead center,
while the engine piston is stopped at top dead center, the pressurized air or gas is admitted to the expansion chamber when this chamber is at its smallest volume and, under the thrust, will increase in volume, thereby producing work,
as the expansion chamber is kept more or less at its maximum volume, the compressed air contained therein then expands in the engine cylinder, thus driving the engine piston back in its downstroke, in turn supplying work,
during the upstroke of the engine piston during the exhaust stroke, the variable volume of the expansion chamber is returned to its smallest volume in order to begin afresh a complete work cycle.

The expansion chamber of the engine according to this invention makes an active contribution to the work. The engine is thus referred to as an engine with “active chamber”.

WO-A1-2005/049968 notably claims a four-phase thermodynamic cycle when it is operating in mono-energy compressed air mode, this being characterized by:
an isothermal expansion without work;
a transfer-slight expansion with work referred to as near-isothermal;
a polytropic expansion with work;
an exhaust at ambient pressure.

Document WO-A1-2008/028881, which discloses a variant of WO-A1-2005/049968, claims the same thermodynamic cycle but using a traditional connecting-rod/crank device. It is preferably supplied with compressed air or any other compressed gas contained in a high-pressure storage reservoir previously expanded to a nominal working pressure in a buffer volume referred to as the working volume. The working volume in the dual-energy version comprises a device for heating the air which is supplied with an additional energy (fossil or some other energy) increasing the temperature and/or the pressure of the air passing through it.

In this type of engine according to WO-A1-2008/028881:
the expansion chamber, referred to as the active chamber, consists of a variable volume equipped with means allowing the production of work and is connected via a passage comprising a shutter whilst allowing it to be isolated from or placed in communication with the volume contained in the engine cylinder above the engine piston at its top dead center;
the pressurized air or gas is admitted to the active chamber when the latter is at its smallest volume and, under the thrust, increases in volume, thereby producing work;
when the active chamber is more or less at its maximum volume, and the engine piston is more or less at top dead center, the intake is closed off, said chamber is placed in communication with the engine cylinder and the compressed air contained therein expands, thus driving the engine piston back in its downstroke, thereby in turn supplying work;
during the expansion, the volume of the active chamber is returned to its minimum volume so that a new cycle can begin afresh.

The expansion chamber of the engine according to the invention makes an active contribution to the work. The engines according to WO-A1-2005/049968 and WO-A1-2008/028881 are referred to as engines with active chamber.

For optimized operation of these latter types of engine it is necessary to take the pressure drops involved in the transfer from the active chamber to the expansion chamber in the case of WO-A1-2008/028881, and the dead volumes generated by construction of the transfer in the case of WO-A1-2005/049968 into consideration.

The present invention proposes to address this problem while at the same time simplifying the construction of the machine.

The engine with active chamber included in the engine cylinder according to the invention uses the same thermodynamic cycles as WO-A1-2005/049968 and WO-A1-2008/028881 described hereinabove, and a traditional connecting-rod/crank device.

The invention thus proposes an engine with an active chamber, comprising at least one piston slidably mounted in a cylinder and driving a crankshaft by means of a traditional connecting-rod/crank device and operating on a four-phase thermodynamic cycle comprising:
an isothermal expansion without work;
a transfer-slight expansion with work referred to as near-isothermal;
a polytropic expansion with work;
an exhaust at ambient pressure;

preferably supplied with compressed air or with any other compressed gas contained in a high-pressure storage reservoir, via a buffer volume referred to as the working volume which is supplied with compressed air, or any other compressed gas, contained in a high-pressure storage reservoir, which is expanded to a medium pressure referred to as the working pressure in a working volume, preferably via a dynamic regulator device, characterized:
in that it comprises at least one piston slidably mounted in at least one cylinder of which the volume swept by the piston is divided into two distinct parts namely a first part constituting the active chamber CA which is included in the cylinder and a second part constituting the expansion chamber;
in that the volume of the cylinder which is swept by the piston is closed at its upper part by a cylinder head comprising at least one intake duct and port and at least one exhaust duct and port and which is set out in such a way that, when the piston is top dead center, the residual volume left between the piston and cylinder head is, by construction, reduced to only the minimum clearances that allow operation without contact between piston and cylinder head;
in that the compressed air or the pressurized gas is admitted to the cylinder on top of the piston and, under the continuous thrust of the compressed air at constant working pressure, the volume of the active chamber increases, producing work representing the near-isothermal transfer phase;
in that the admission of the compressed air, or of the pressurized gas, into the cylinder is closed off as soon as the maximum volume of the active chamber CA is reached, and that the amount of compressed air, or of the pressurized gas, contained in said active chamber then expands, driving back the piston over the second part of its travel which determines the expansion chamber CD, thereby producing work that thus brings about the expansion phase;
in that, when the piston has reached bottom dead center, the exhaust port is then opened to allow the exhaust phase to take place during the upstroke of the piston over its entire travel.

The maximum volume of the included active chamber CA in the engine cylinder and the volume of the expansion chamber CD are sized so that, at the nominal operating pressure of the engine, the pressure at the end of expansion at the bottom dead center is close to atmospheric pressure.

For example, at the nominal operating pressure of 20 bar, an engine with a total cylinder capacity of 300 cm³—which means the volume of the active chamber plus the volume of the expansion chamber—the maximum volume of the active chamber CA included in the cylinder will be 35 cm³, reached at 45 degrees crank angle after top dead center, and the volume of the expansion chamber CD will be 265 cm³, and the pressure at bottom dead center on opening of the exhaust will be 1.03 bar.

The engine according to the invention is advantageously equipped with a variable throughput regulator in accordance with WO-A1-03/089764, referred to as a dynamic regulator, making it possible to supply the working volume at its nominal operating pressure with compressed air for the high-pressure storage reservoir by carrying out an expansion without work of the isothermal type.

The thermodynamic cycle of the engine with active chamber according to the invention is identical to that of WO-A1-2005/049968 and of WO-A1-2008/028881. It is characterized by isothermal expansion without work permitted by the dynamic regulator, followed by a transfer accompanied with a very slight near-isothermal expansion—for example a capacity of 3 000 centimeters cubed in a capacity of 3 050 centimeters cubed—with work by using the pressure of the air contained in the work volume during the filling of the expansion chamber, then followed by polytropic expansion of the expansion chamber in the engine cylinder with work and a considerable reduction in temperature, ending with exhausting of the expanded air to the atmosphere.

It is not unheard of for the temperature of the exhaust of such a type of engine to drop to values of the order of −75 to −100 degrees centigrade below ambient temperature.

For preference, and notably in mono-energy operation using compressed air, the engine with active chamber included in the cylinder according to the invention comprises several successive cylinder stages in cascade, each designed and operating on the principle of the invention that has just been described, these consecutive cylinders having increasing cylinder capacities.

The first cylinder, with the smallest cylinder capacity, is supplied with compressed air by the working volume.

The next cylinder or cylinders of increasing cylinder capacities are supplied with compressed air by the exhaust from the cylinder upstream of/preceding it.

One or more heat exchangers that exchange heat with the atmosphere is/are positioned between each cylinder, namely between two consecutive cylinders, to increase the temperature of the air at the exhaust from the preceding cylinder and bring it close to ambient temperature thus increasing the volume of the air exhausted.

The total cylinder capacity, the volume of the active chamber and the volume of the expansion chamber of each cylinder, are sized in such a way that the volume of air exhausted from each of the cylinders, namely the volume of the total cylinder capacity increased by the increase in volume brought about by the rise in temperature in the exchangers, are substantially equivalent to the maximum volume of the active chamber of the next cylinder.

Depending on the number of cylinders chosen, and on the total cylinder capacity of the engine, the characteristics of each cylinder are defined in such a way that the exhaust temperatures of each cylinder are substantially identical. As a result, the factors that lower the exhaust pressure are thus likewise substantially similar.

By way of nonlimiting example, a 3-cylinder engine according to the invention, with a total cylinder capacity of 508.7 cm³, supplied from a working volume at a nominal pressure of 100 bar will have the following characteristics:

| | | Cylinder | Cylinder | Cylinder |
|---|---|---|---|---|
| | | 1 | 2 | 3 |
| Cylinder capacity | cm³ | 19.7 | 89 | 400 |
| Volume of the active chamber | cm³ | 5.5 | 26 | 129 |
| included | | | | |
| Volume of the expansion | cm³ | 14.2 | 63 | 271 |
| chamber | | | | |
| Intake pressure | bar | 100 | 22.3 | 4.7 |
| Intake temperature | K | 293 | 293 | 293 |
| Exhaust pressure | bar | 22.3 | 4.7 | 1 |
| Exhaust temperature | K | 197 | 195 | 195 |

In its dual-energy application according to the invention, and in the mode that uses additional fuel, the compressed air at ambient temperature contained in the working volume is heated at constant pressure using additional energy in a thermal heater. This arrangement makes it possible to increase the amount of available and usable energy because of the fact that the compressed air, before being introduced into the active chamber CA, will increase in temperature and increase in volume thus increasing the range of a machine (for example a motor vehicle) equipped with the engine according to the invention, in proportion with said increase in volume.

This is an isobaric heating and multiplying the temperature by a factor of two doubles the useful volume of compressed air, and so on.

Thus, a 200-liter reservoir of compressed air at 200 bar, namely 40 m³ of air at 293 K (20° Celsius) makes 80 m³ of compressed air available at 586 K (i.e. 313° Celsius).

The combustion, which begins at ambient temperature, allows considerable results to be achieved with very little energy, remaining below the temperatures at which the particularly pollutant oxides of nitrogen form. The use of a thermal heater device, or thermal heater, has the advantage that it is possible to make use of clean continuous combustions that can be catalyzed or rid of pollution by any known means with a view to obtaining minimalistic pollutant emissions.

The thermal heater may, for its energy source, use a fossil fuel such as petroleum, diesel oil or even LPG or vehicle natural gas (VNG). The heater may also use biofuels or alcohol/ethanol thus making it possible to achieve dual-energy operation with external combustion, in which a burner will bring about a rise in temperature. The heater may also use thermochemical processes to bring about this rise in temperature.

According to an alternative form of the invention, the engine with active chamber uses solar energy to heat up the compressed air and for this purpose is equipped with a parabolic solar collector, or with any other system for collecting solar energy, focusing in a chamber that allows the temperature of the compressed air passing through the working volume to be increased.

This feature makes it possible to increase the amount of available and usable energy through the fact that the compressed air, before being introduced into the cylinder, will increase in temperature and increase in volume thereby making it possible to increase the range of the machine fitted with the engine according to the invention, in proportion with said increase in volume.

The various energies used can be used separately or in combination.

In the case of a dual-energy engine comprising several cylinders, the means for heating the air using additional energy are preferably installed between the last two cylinders in order to make it possible to conserve the addition of ambient thermal energy when increasing the temperature in the heat exchanger or exchangers positioned between the preceding cylinders.

However, heating and/or top-up heating devices may be used between each pair of cylinders without thereby changing the principle of the present invention.

According to one alternative form of this arrangement, after each stage, the exhaust air is directed to a single multi-stage heater thus making it possible to employ just one combustion source.

In the mode of operation using additional energy, the thermodynamic cycle of the first cylinder therefore comprises five phases:
isothermal expansion;
increase in temperature;
transfer-slight expansion with work referred to as near-isothermal;
polytropic expansion with work;
exhaust at ambient pressure;

and the thermodynamic cycle of the next/consecutive cylinders in the case of a multi-cylinder engine comprises four phases:
increase in temperature;
transfer-slight expansion with work referred to as near-isothermal;
polytropic expansion with work;
exhaust at ambient pressure.

In the compressed air mode, for example on a motor vehicle in an urban situation, only the pressure of the compressed air in the high-pressure reservoir is used for operation. In operation in the mode using additional energy, fossil or other energy, for example on a motor vehicle on the highway, heating of the working volume is then commanded, thus making it possible to increase the temperature of the air passing through the working volume, and therefore the volume and/or pressure that can be used for the work of charging the active chamber and expansion chamber.

The engine according to the invention is controlled by torque and by speed, by controlling the pressure in the working volume, this control advantageously being performed by the dynamic regulator, when operating in dual-energy mode with additional energy (fossil or other energy), and by means of an electronic computer with which the engine is equipped and which controls the amount of additional energy supplied, according to the pressure in said working volume.

According to an alternative form of the invention that allows the engine according to the invention autonomous dual-energy operation, the engine with active chamber is coupled to an air compressor which, while it is operating using additional energy, supplies the high-pressure compressed air storage reservoir with compressed air. For preference, a heat exchanger is positioned between the compressor and the storage reservoir, so that the high-temperature high-pressure compressed air leaving the compressor is returned in the reservoir to a temperature close to ambient temperature.

The mono-energy and dual-energy engine with active chamber thus equipped operates in three modes:
operation in mono-energy mode—zero pollution—with air previously compressed contained in the high-pressure storage reservoir;
operation in dual-energy mode, with the air previously compressed contained in the high-pressure storage reservoir, plus with the additional energy supplied by the thermal heater;
operation in autonomous dual-energy mode with the air compressed in the reservoir by an engine-driven air compressor, plus the additional energy supplied by the thermal heater.

The heat exchangers may be air/air or air/liquid heat exchangers or any other device or gas that produces the desired heating effect.

The engine with active chamber according to the invention can be used on all land, sea, rail, aeronautical vehicles. The engine with active chamber according to the invention may also and advantageously find an application in backup generator sets, and likewise in numerous domestic cogeneration applications that produce electricity, heating and climate control.

Other objects, advantages and features of the invention will become apparent from reading the nonlimiting description of a number of embodiments, which is given with reference to the attached drawings in which:

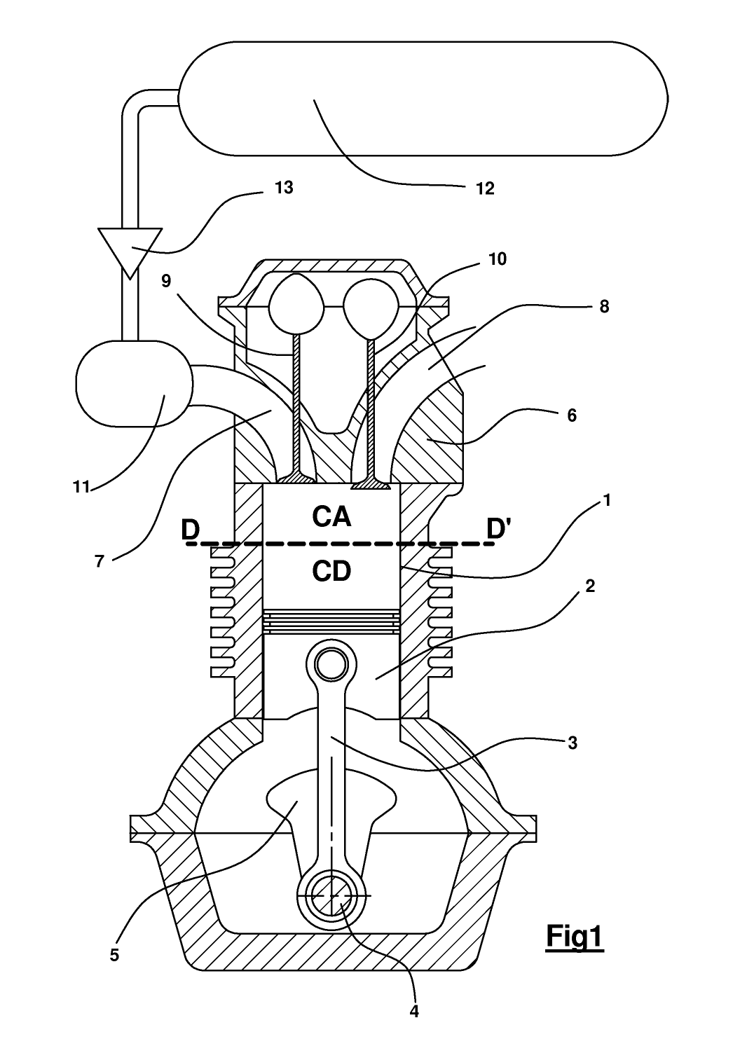

FIG. 1 schematically depicts an engine according to the invention, with an active chamber included within the cylinder, which is illustrated in axial cross section at bottom dead center, and its compressed-air supply device;

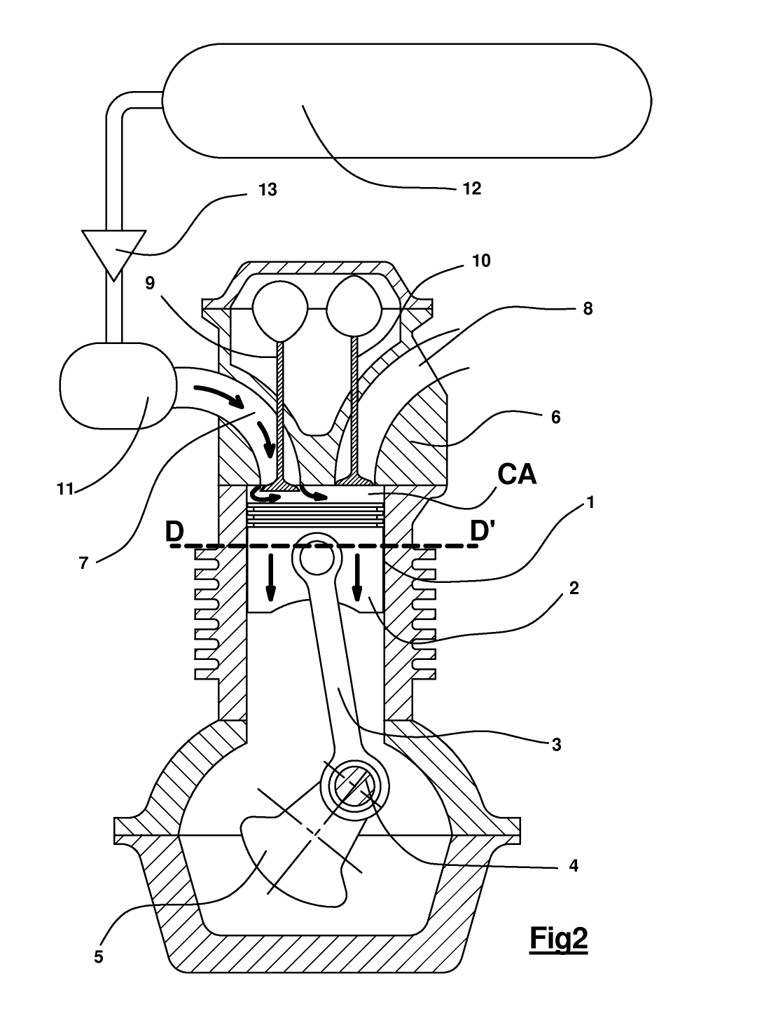

FIGS. 2 to 4 depict, in schematic cross-sectional views, the various phases of operation of the engine according to the invention;

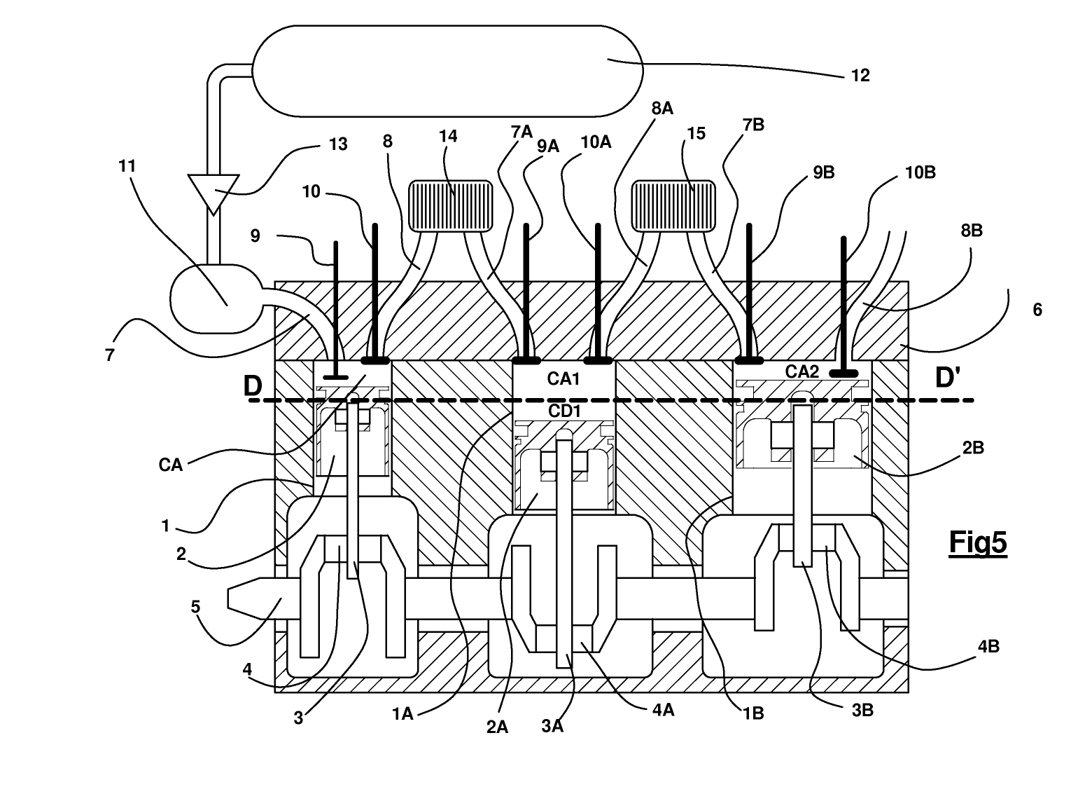

FIG. 5 depicts, viewed in cross section, a multi-cylinder engine with active chamber according to the invention, having three stages;

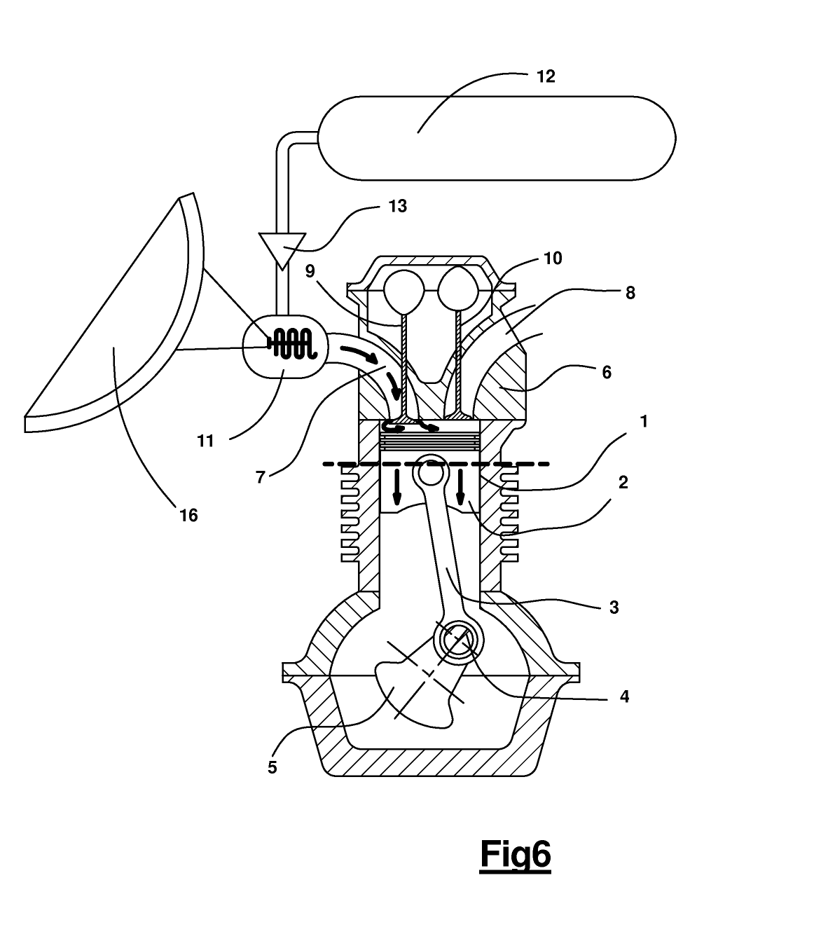

FIG. 6 schematically depicts an engine with active chamber according to the invention, viewed in cross section, and its high-pressure air supply device comprising a device for heating up the compressed air using a parabolic solar collector;

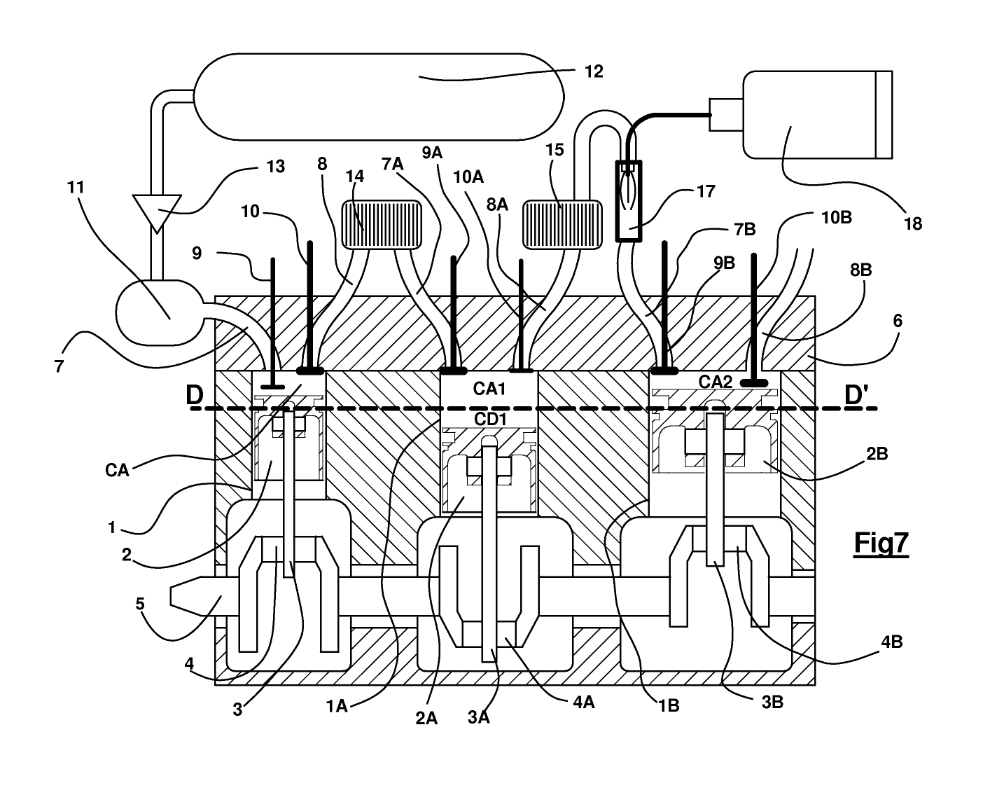

FIG. 7 depicts, viewed in cross section, a multi-cylinder engine and its heating device using combustion;

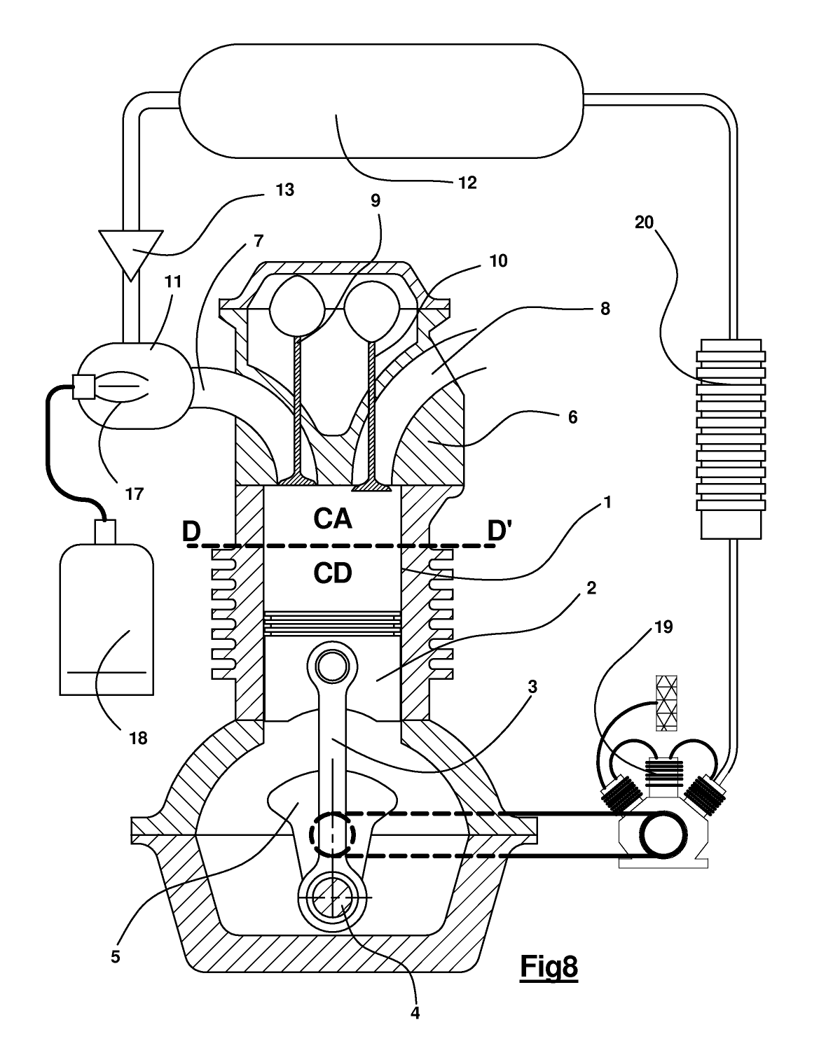

FIG. 8 schematically depicts an engine with active chamber according to the invention, coupled to a compressor supplying the storage reservoir.

FIG. 1 depicts an engine with active chamber according to the invention and shows an engine cylinder 1 in which there slides a piston 2 connected by a connecting rod 3 to the crank pin 4 of a crankshaft 5.

The volume of the engine cylinder 1 according to the invention which is swept by the piston 2 is divided along an imaginary line DD′ (which corresponds to a dividing plane orthogonal to the axis of the cylinder) into two parts: a first part constituting the active chamber CA, which is thus included within the cylinder, and a second part constituting the expansion chamber CD.

The engine cylinder 1 is capped by a cylinder head 6, comprising an intake duct 7 and an exhaust duct 8, as well as associated means for closing off said ducts, these means here being intake 9 and exhaust 10 valves respectively.

The intake duct is connected to a working volume 11 at a working pressure which is supplied from a high-pressure reservoir 12 through a dynamic regulator 13.

The high-pressure compressed air contained in the high-pressure storage reservoir 12 is expanded to the working pressure in the working volume 11 through the dynamic regulator 13 thereby carrying out the first phase of the thermodynamic cycle: isothermal expansion without work.

A device (not depicted), controlled by the throttle pedal, controls the dynamic regulator 13 to regulate the pressure in the working chamber and thus allow control of the engine.

When the piston 2 is at top dead center, by construction, the residual volume between the upper face of the piston and the portion of cylinder head 6 opposite it is zero, or near zero, and the volume of the active CA and expansion CD chambers is therefore zero.

From piston top dead center onwards, the volume of the cylinder swept by the piston and situated above the upper face of the piston will increase progressively thus creating the active chamber CA and then the expansion chamber CD, in succession.

The downstroke of the piston 2 in the cylinder 1 thus comprises, consecutively, a first “upper” part corresponding to the progressive formation of the chamber referred to as the active chamber CA, and a second “lower” part corresponding to the progressive formation of the chamber referred to as the expansion chamber CD.

FIG. 2 depicts the engine with active chamber according to the invention during an intake phase, the intake valve 9 having been opened as soon as top dead center was reached. The compressed air at nominal working pressure contained in the working volume 11 is supplied at constant pressure to the included active chamber CA the volume of which increases progressively, and drives back the piston 2 in its downstroke, producing work and performing the second phase of the thermodynamic cycle: transfer with slight expansion with work referred to as near-isothermal.

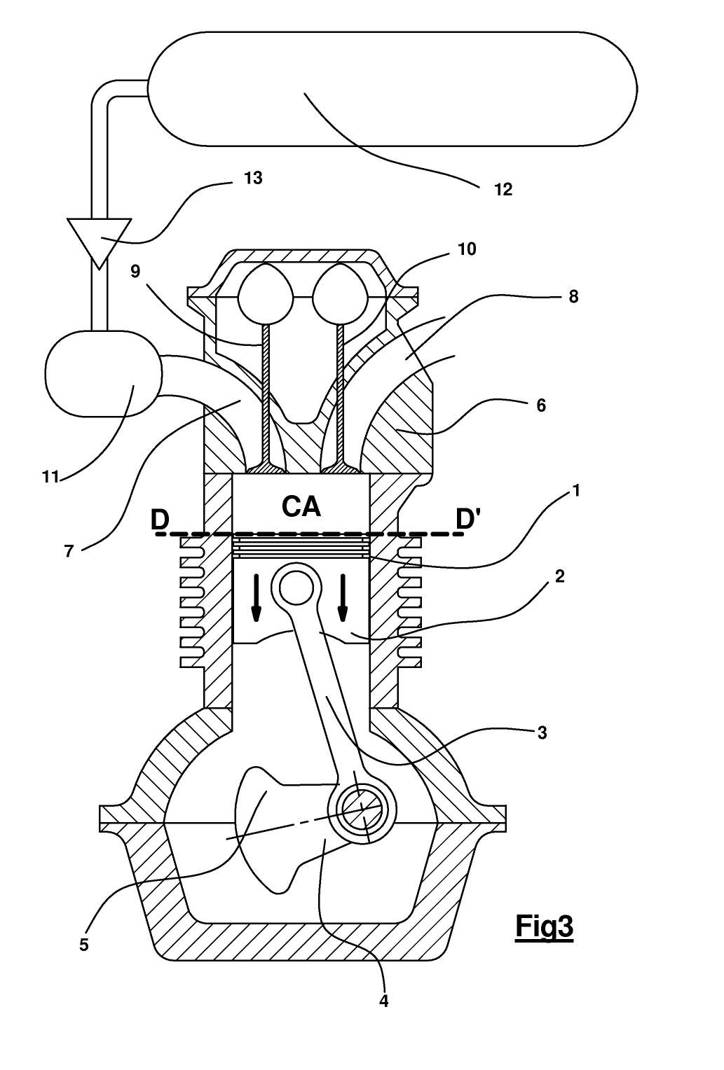

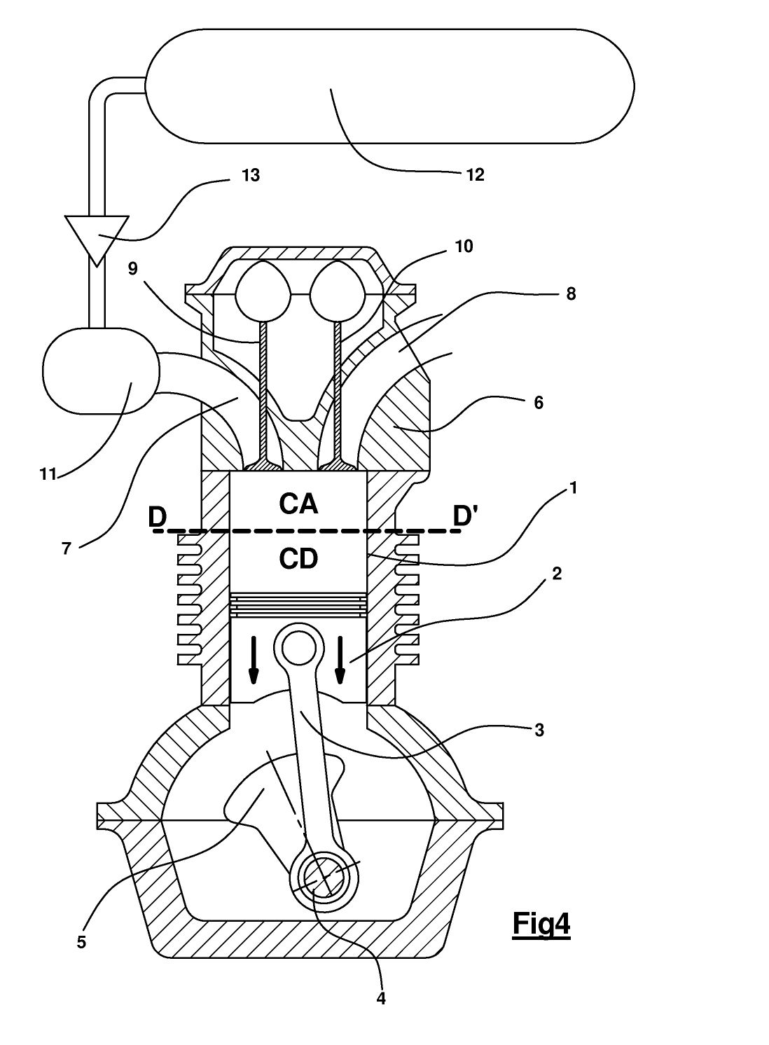

FIG. 3 depicts the engine with included active chamber CA according to the invention when the piston 2 reaches the line DD', at which moment the volume of the active chamber CA is at its maximum and the pressure in the active chamber is at the nominal working pressure which is identical to the pressure of the air contained in the working volume 11. The intake valve 9 is then closed and interrupts the arrival of pressurized air. The compressed air at nominal pressure contained in the active chamber CA then expands, driving back the piston 1 toward its bottom dead center (FIG. 4), performing motive expansion work and carrying out the third phase of the thermodynamic cycle: polytropic expansion with work.

The piston 1 then reaches bottom dead center (FIG. 1), which corresponds to the maximum available volume of the cylinder swept by the piston, and the exhaust valve 10 is then opened in order to remove the expanded air—at a pressure close to atmospheric pressure—to the atmosphere through the exhaust duct 8 during the piston upstroke, thereby carrying out the fourth phase of the thermodynamic cycle: exhaust at ambient/atmospheric pressure.

FIG. 5 depicts a multi-cylinder engine with three stages of increasing cylinder capacity according to the invention. The figure shows, from left to right, the first cylinder 1 of smallest cylinder capacity, in which there slides a piston 2 connected by a connecting rod 3 to the crank pin 4 of a crankshaft 5. This engine cylinder 1 is divided along a line DD′ into two parts: an active chamber CA and a partial expansion chamber CD (not visible in the drawing). The engine cylinder 1 is capped by a cylinder head 6 comprising an intake duct 7 and an exhaust duct 8 as well as means for closing off these ducts which means here are intake 9 and exhaust 10 valves. The intake duct 7 is connected to a working volume 11 at the working pressure which is supplied from the high-pressure reservoir 12 through a dynamic regulator 13. The exhaust duct 8 opens onto the inlet of a first air/air heat exchanger 14.

The second stage consists of a second cylinder 1A, the cylinder capacity of which is greater than that of the first cylinder 1, in which there slides a piston 2A connected by a connecting rod 3A to the crank pin 4A of the common crankshaft 5. The second engine cylinder 1A is divided along a line DD′ into two parts: a second active chamber CA1, the volume of which is substantially equal to the cylinder capacity of the first cylinder 1 increased by the increase in volume brought about by heating the exhaust in the air/air exchanger 14, and a second partial expansion chamber CD1. The second engine cylinder 1A is capped by a common cylinder head 6 comprising an intake duct 7A and an exhaust duct 8A, as well as means for shutting off said ducts which here are intake 9A and exhaust 10A valves. The intake duct 7A is connected to the outlet of the air/air heat exchanger 14 which supplies it with compressed air at the constant pressure of the exhaust from the first cylinder. The exhaust duct 8A opens onto the inlet of a second air/air heat exchanger 15.

The third stage consists of a third cylinder 1B the cylinder capacity of which is even greater and is greater than the cylinder capacity of the second cylinder 1A, in which there slides a piston 2B connected by a connecting rod 3B to the crank pin 4B of the common crankshaft 5. The engine cylinder 1B is divided along a line DD′ into two parts: a third active chamber CA2 the volume of which is substantially equal to the cylinder capacity of the second cylinder 1A increased by the increase in volume brought about by heating the exhaust in the second air/air heat exchanger 15 and a third expansion chamber CD2, not visible in the drawing. The engine cylinder 1B is capped by the cylinder head 6, which here is common to all three cylinders, comprising an intake duct 7B and an exhaust duct 8B as well as means for closing off these ducts which here are intake 9B and exhaust 10B valves. The intake duct 7B is connected to the outlet of the second air/air heat exchanger 15 which supplies it with compressed air at a constant pressure of the exhaust of the second cylinder 1A. The exhaust duct 8B opens to the atmosphere.

The high-pressure compressed air contained in the high-pressure storage reservoir 12 is expanded by the dynamic regulator 13 to a nominal working pressure which, in this case, may be far higher—for example 100 bar—than in the case of a single-cylinder engine like the one described above.

The values of the volumes, pressures and temperatures indicated in the following description of the operation are given by way of nonlimiting example of one realistic and possible embodiment of the invention.

When the piston 2 of the first cylinder 1 is at top dead center, the intake valve 9 is opened and the compressed air at nominal working pressure contained in the working volume 11 is supplied at constant pressure to the included active chamber CA of the first cylinder 1 and drives back the piston 2 in its downstroke, producing work. The piston 2 reaches the line DD′ at which the volume of the active chamber CA, which is 5.5 cc, is at the nominal working pressure of 100 bar identical to the pressure of the air contained in the working volume 11. The intake valve 9 is closed and interrupts the arrival of pressurized air. The compressed air at nominal pressure contained in the active chamber CA1 expands partially in the expansion chamber, driving the piston 1 toward bottom dead center, performing motive expansion work.

During this partial expansion, the compressed air cools to minus 78 degrees. The first piston 1 arrives at bottom dead center while the pressure of the air contained in the cylinder 1 of a total given volume of 90 cm³ is still great, of the order of 20 bar. The exhaust valve 10 is then opened and the piston 1 drives, at near-constant pressure, the compressed air into the air/air exchanger 14 in which it will warm up and return substantially to ambient temperature, increasing in volume from 20 cm³ to 26 cm³.

When the piston 2A of the second cylinder 1A is at top dead center, the intake valve 9A is opened and the compressed air at the secondary working pressure contained in the exchanger 14 is fed at constant pressure (20 bar) to the second included active chamber CA1 of the cylinder 1A and drives the second piston 2A in its downstroke, producing work. The piston 2A reaches the line DD′ at which the volume of the second active chamber CA1, which is 26 cm³, is at the secondary working pressure of 20 bar, identical to the pressure of the air contained in the exchanger 14. The intake valve 9A is closed and interrupts the arrival of pressurized air. The compressed air at the secondary pressure (20 bar) contained in the second active chamber CA1 then partially expands, driving the second piston 1A toward bottom dead center, producing motive expansion work.

During this partial expansion, the compressed air cools to minus 78 degrees. The second piston 1A reaches bottom dead center when the pressure of the air contained in the second cylinder 1A, with a total given volume of 90 cm³, is still great and of the order of 5 bar. The exhaust valve 10A is then opened and the second piston 1A drives, at near-constant pressure, the compressed air into the second air/air exchanger 15 in which it will heat up and return substantially to ambient temperature, increasing in volume from 90 cm³ to 129 cm³.

When the third piston 2B of the third cylinder 1B is at top dead center, the intake valve 9B is opened and the compressed air at the tertiary working pressure—5 bar—contained in the second exchanger 15 is supplied at constant pressure to the third included active chamber CA2 of the third cylinder 1B and drives the piston 2B in its downstroke, producing work. The piston 2B reaches the line DD′ at which the volume of the third active chamber CA2—which is 129 cm³—is at the tertiary working pressure of 5 bar—identical to the pressure of the air contained in the second exchanger 15. The intake valve 9B is closed and interrupts the arrival of pressurized air. The compressed air at the tertiary pressure contained in the third active chamber CA2 then expands completely, driving the third piston 1B toward bottom dead center, thereby producing motive expansion work, to attain atmospheric pressure.

During this expansion, the compressed air cools to minus 78 degrees. The third piston 1B arrives at bottom dead center when the pressure of the air contained in the third cylinder 1B, which has a total given volume of 400 cm³, is close to atmospheric pressure, and the exhaust valve 8B is then opened and the third piston 2B drives into the atmosphere the air contained in the third cylinder 1B.

FIG. 6 depicts an engine with included active chamber according to the invention and the high-pressure air supply device therefor which comprises a device for heating up the compressed air using a parabolic solar collector 16 which focuses in the working volume and allows the temperature of the compressed air passing through it to be increased. This arrangement makes it possible to increase the amount of available and usable energy through the fact that the compressed air, before being introduced into the included active chamber, will increase in temperature and increase in pressure and/or in volume allowing an increase in engine performance and/or in the range of the vehicle equipped with the engine.

FIG. 7 depicts the multi-cylinder engine with active chamber according to the invention in its dual-energy version, and indicates a schematic device 17 for heating the compressed air which device is positioned between the last (second) heat exchanger 15 and the intake side of the last (third) cylinder with supply of additional energy. This heating device in this instance is a burner 17 supplied from a gas cylinder 18. The combustion performed is therefore here an external/internal combustion and allows a considerable increase in the volume and/or pressure of the compressed air derived from the exhaust of the preceding cylinder (second cylinder).

FIG. 8 depicts the engine with active chamber according to the invention working in autonomous dual energy mode with fossil or vegetable-based so-called additional energy, according to an alternative form of the invention, it drives a compressed air compressor 19 which supplies the storage reservoir 12 through an air/air heat exchanger 20. The overall operation of the engine is the same as that described previously with reference to FIGS. 1 to 4. However, this additional arrangement allows the storage reservoir to be filled during use, by using additional energy.

By comparison with the prior art consisting of the preceding inventions of the inventors relating to engines of the type referred to as the “active chamber” type, the present invention offers a method for controlling the operation of an engine comprising at least one cylinder closed by a cylinder head and swept by a piston, with the possibility of stopping the piston at top dead center, which allows an active chamber CA to be functionally and thus structurally incorporated/included in the engine cylinder, which active chamber in the preceding inventions had been “external” to the cylinder to which this “external” active chamber was connected.

This inclusion/incorporation of the active chamber CA in the cylinder allows not only structural simplification of a compressed gas or air engine referred to as an active chamber engine, but also an improvement to engine performance and engine efficiency.

The engine with active chamber according to the invention has been described as operating using compressed air. However, it may use any compressed gas/high-pressure gas whatsoever, without thereby departing from the scope of the claimed invention.

The invention is not restricted to the embodiments described and depicted: the materials, control means, devices described can vary within the bounds of equivalents, to produce the same results. The number of engine cylinders, their cylinder capacities, the maximum volume of the active chamber with respect to the displacement of the cylinder(s) and the number of expansion stages, may vary.

1. An engine with an active chamber, comprising at least one piston (2) slidably mounted in a cylinder (1) and driving a crankshaft (5) by means of a traditional connecting-rod/crank device (3, 4) and operating on a four-phase thermodynamic cycle comprising:
an isothermal expansion without work;
a transfer-slight expansion with work referred to as near-isothermal;
a polytropic expansion with work;
an exhaust at ambient pressure;
preferably supplied with compressed air or with any other compressed gas contained in a high-pressure storage reservoir (12), via a buffer volume referred to as the working volume (11) which is supplied with compressed air, or any other compressed gas, contained in a high-pressure storage reservoir (12), which is expanded to a medium pressure referred to as the working pressure in a working volume (11), preferably via a dynamic regulator device (13),
characterized:
in that it comprises at least one piston (2) slidably mounted in at least one cylinder (1) of which the volume swept by the piston is divided into two distinct parts namely a first part constituting the active chamber (CA) which is included in the cylinder and a second part constituting the expansion chamber (CD);
in that the volume of the cylinder (1) which is swept by the piston (2) is closed at its upper part by a cylinder head (6) comprising at least one intake duct and port (7) and at least one exhaust duct and port (9) and which is set out in such a way that, when the piston (2) is top dead center, the residual volume left between the piston and cylinder head (6) is, by construction, reduced to only the minimum clearances that allow operation without contact between piston and cylinder head;
in that the compressed air or the pressurized gas is admitted to the cylinder on top of the piston and, under the continuous thrust of the compressed air or any other gas, at constant working pressure, the volume of the active chamber (CA) increases, producing work representing the near-isothermal transfer phase;
in that the admission of the compressed air, or of the pressurized gas, into the cylinder is closed off as soon as the maximum volume of the active chamber (CA) is reached, and that the amount of compressed air, or of a pressurized gas, contained in said active chamber then expands, driving back the piston over the second part of its travel which determines the expansion chamber (CD), thereby producing work that thus brings about the expansion phase;
in that, when the piston has reached bottom dead center, the exhaust port is then opened to allow the exhaust phase to take place during the upstroke of the piston over its entire travel.

2. The engine with active chamber as claimed in claim 1, characterized in that the maximum volume of the included active chamber (CA) and the volume of the expansion chamber (CD) are sized so that, at the nominal operating pressure of the engine, the pressure at the end of expansion at the bottom dead center is close to atmospheric pressure.

3. The engine with active chamber as claimed in claim 1, characterized:
in that it comprises several consecutive cylinders (1; 1A; 1B) of increasing cylinder capacity, each operating on the same principle that has just been described;
in that the first cylinder of smallest cylinder capacity is supplied with compressed air, or with the pressurized gas, by the working volume (11) and in that the next cylinder or cylinders are each supplied with the exhaust (8A, 8B) from the preceding cylinder;
in that one or more heat exchanger(s) for exchanging heat with the atmosphere is/are positioned between each cylinder allowing the air temperature of the exhaust from the preceding cylinder to be increased to bring it back close to ambient temperature and thus increase the volume of the air exhausted.

4. The engine active chamber as claimed in claim 1, in its dual-energy application, characterized in that the working volume (13) comprises a heating device (17) operating on additional energy, either fossil or other than compressed air or than pressurized gas, at constant pressure, said heating device making it possible to increase the temperature of the air or of the gas passing through it and to increase the amount of available and usable energy as a result of the fact that the compressed air or the pressurized gas, before being introduced into the active chamber, will increase in temperature and increase in volume thereby making it possible to increase the range of a machine fitted with the engine according to the invention, in proportion with said increase in volume.

5. The engine with active chamber as claimed in claim 3, characterized in that a heating device at constant pressure is positioned between the last two of said consecutive cylinders, after the exchanger, said device making it possible to increase the temperature of the air or of the gas passing through it and to increase the amount of available and usable energy through the fact that the compressed air, or the pressurized gas, before being introduced into the active chamber, will increase in temperature and increase in volume, thereby increasing the range of a machine equipped with the engine according to the invention.

6. The engine with active chamber in its dual-energy application, as claimed in claim 4, characterized in that the heating device (25) comprises a parabolic solar collector focusing in the working volume to increase the temperature of the compressed air or of the pressurized gas and increase the amount of usable and available energy through the fact that the compressed air, or the pressurized gas, before being introduced into the active chamber, will increase in temperature and increase in volume thereby increasing the range of a machine equipped with the engine according to the invention.

7. The engine with active chamber as claimed in claim 1, characterized in that the torque and the speed of the engine are controlled by controlling the pressure in the working volume (11).

8. The engine with active chamber as claimed in claim 4, characterized in that, when operating in dual-energy mode with additional energy, an electronic computer controls the amount of energy supplied as a function of the pressure of the compressed air or of the pressurized gas, and therefore of the mass of air or of gas introduced into the working volume.

9. The engine with active chamber as claimed in claim 1 in its autonomous dual-energy application, characterized in that the engine is coupled to and drives an air or gas compressor that, when operating with additional energy, allows the storage reservoir to be supplied with compressed air or with pressurized gas.

10. The engine with active chamber as claimed in claim 9, characterized in that a heat exchanger is positioned between the compressor and the storage reservoir so that the compressed air or the gas at high pressure and high temperature leaving the compressor reverts in the reservoir to a temperature close to ambient temperature.

11. The engine with active chamber as claimed in claim 1, characterized in that it operates in three modes that can be made separately or in combination:
mono-energy zero pollution operation, with air or gas previously compressed and contained in the high-pressure storage reservoir;
dual-energy operation with air or gas, previously compressed contained in the reservoir plus the additional energy supplied by a heating device;
autonomous dual-energy operation with air or gas compressed in the reservoir by a compressor driven by the engine plus the additional energy supplied by the heating device.

12. The engine active chamber as claimed in claim 3, in its dual-energy application, characterized in that the working volume (13) comprises a heating device (17) operating on additional energy, either fossil or other than compressed air or than pressurized gas, at constant pressure, said heating device making it possible to increase the temperature of the air or of the gas passing through it and to increase the amount of available and usable energy as a result of the fact that the compressed air or the pressurized gas, before being introduced into the active chamber, will increase in temperature and increase in volume thereby making it possible to increase the range of a machine fitted with the engine according to the invention, in proportion with said increase in volume.

13. The engine with active chamber in its dual-energy application, as claimed in claim 5, characterized in that the heating device (25) comprises a parabolic solar collector focusing in the working volume to increase the temperature of the compressed air or of the pressurized gas and increase the amount of usable and available energy through the fact that the compressed air, or the pressurized gas, before being introduced into the active chamber, will increase in temperature and increase in volume thereby increasing the range of a machine equipped with the engine according to the invention.

14. The engine with active chamber in its dual-energy application, as claimed in claim 5, characterized in that the heating device (25) comprises a parabolic solar collector focusing in the working volume to increase the temperature of the compressed air or of the pressurized gas and increase the amount of usable and available energy through the fact that the compressed air, or the pressurized gas, before being introduced into the active chamber, will increase in temperature and increase in volume thereby increasing the range of a machine equipped with the engine according to the invention.

15. The engine with active chamber in its dual-energy application, as claimed in claim 6, characterized in that the heating device (25) comprises a parabolic solar collector focusing in the working volume to increase the temperature of the compressed air or of the pressurized gas and increase the amount of usable and available energy through the fact that the compressed air, or the pressurized gas, before being introduced into the active chamber, will increase in temperature and increase in volume thereby increasing the range of a machine equipped with the engine according to the invention.
